(19) United States
(12) Patent Application Publication
(10) Pub. No.: US 2014/0227662 A1
(43) Pub. Date: Aug. 14, 2014

(54) CERAMIC IMPLANT SYSTEM

(71) Applicant: Z-Systems Schweiz AG, Oensingen (CH)

(72) Inventors: Rubino Di Girolamo, Oberageri (CH); Thomas Hug, Erlenbach (CH); Roger Staudenmann, Busswil b. Buren (CH); Ernst Thomke, Grenchen (CH)

(73) Assignee: Z-Systems Schweiz AG, Oensingen (CH)

(21) Appl. No.: 14/179,652

(22) Filed: Feb. 13, 2014

(30) Foreign Application Priority Data
Feb. 14, 2013 (CH) 00460/13

(51) Int. Cl. A61C 8/00

(52) U.S. Cl. CPC A61C 8/0012; A61C 8/0069
USPC 433/174

(57) ABSTRACT

The ceramic implant system includes an implant with a proximal region having an inner cone, and an abutment with a distal region having an outer cone. The distal region of the abutment and the proximal region of the implant in a clamping region in each case include at least one conical clamping surface which, in pairs, are adapted to one another in an accurately fitting manner such that the abutment and the implant of the ceramic implant system are connectable by way of a clamping connection.

### BACKGROUND OF THE INVENTION

1. Field of the Invention

The invention lies in the field of dental medicine and relates to a ceramic implant system comprising a ceramic implant and an abutment.

2. Description of Related Art

Two-part and multi-part dental implant systems, apart from the implant that for the larger part is anchored in the bone, comprise an abutment that serves for fastening a superstructure such as for example a crown or a denture. Most dental implants in the state of the art are manufactured of a ductile material such as titanium or titanium alloys. With two-part implants, the implant is mostly manufactured of a ductile material such as titanium or titanium alloys and the abutment is often manufactured of a ductile material or of ceramic. The abutment is mostly fastened in the implant with an abutment screw of a ductile material.

Ceramic implants compared to titanium implants however have some big advantages with regard to their excellent biocompatibility, and they are often also preferred for aesthetic reasons.

However, compared to titanium implants, ceramic implants have the disadvantage that ceramic material, in particular, oxide ceramic such as ceramic based on zirconium oxide or ceramic based on aluminium oxide is a brittle material. This in particular leads to an increased proneness to breakage and demands more complicated manufacturing methods in comparison to titanium implants. It remains a challenge to match the technical design of ceramic implant systems to the brittle material characterises of the ceramic material.

The increased proneness to breakage due to the brittle ceramic material has a greater effect with two-part implant systems than with single-part implants. This is because the connection between the ceramic implant implanted in the bone and the abutment arranged in the gum region proximally of the implant is particularly prone to breakage, in particular with a screw connection between the implant and abutment. For this reason, there are single-part ceramic implants as are described in the state of the art, for example in EP 1 617 783, which do not also have this additional proneness to breakage caused by the abutment-implant connection.

However, in dental medicine practice, it is indeed two-part implant systems that are often preferred to over single-part implants. Due to the different combination possibilities of a multi-part implant system, they are characterised by way of particularly comprehensive application possibilities in dental prosthetics. A further advantage of two-part implants is the fact that they ensure a covered healing-in for the ingrowth of the implant in the bone, whereas one-part implants in the healing-in phase project out of the gum and must be protected from external influences. Often, multi-part implant systems are advantageously also equipped with multiple-comparable implant platforms and with abutments adapted for commercially available female systems. A further great advantage of two-part implant systems is that angled abutments can also be connected to the implant.

Two-part ceramic implant systems are also described in the state of the art, in which systems the abutment is fastened in the implant with a bonding connection, for example in EP 1 713 411 or in CH 703 012. However, it has been found that two-part ceramic implant systems even with a bonding connection also have an increased proneness to breakage compared to comparable single-part ceramic implants.

### BRIEF SUMMARY OF THE INVENTION

It is therefore the object of the present invention, to provide a ceramic implant system which is two-part and is characterised by a good breakage-resistance, which is comparably as good as those of single-part implants with an as identical as possible outer contour and which have the advantages of two-part implants which are mentioned above.

This object is achieved by a ceramic implant system according to claim 1. The dependent claims claim further embodiments.

The ceramic implant system according to the invention comprises an implant with a proximal region having an inner cone, and an abutment with a distal region having an outer cone. The distal region of the abutment and the proximal region of the abutment in a clamping region in each case comprise a pair of conical clamping surfaces that in pairs are adapted to one another in an accurately fitting manner such that the abutment and the implant of the ceramic implant system are connectable by way of a clamping connection.

The ceramic implant system is defined as a two-part or a multi-part dental implant system and, apart from the implant and the abutment, can yet contain further parts. If not stated otherwise, the term ceramic implant system is also indicated by the term implant system in this text.

The implant of the ceramic implant system consist of ceramic material, in particular of oxide ceramic such as ceramic based on zirconium oxide, in particular yttrium-stabilised ceramic based on zirconium oxide or ceramic based on aluminium oxide. The abutment in some embodiments likewise consists of ceramic material. In other embodiments, the abutment contains ceramic material as well as other materials, such as parts of titanium or titanium alloys, or the abutment consists of one or of several non-ceramic materials.

The clamping region of the connected implant system or of the implant and of the abutment, is a region of the surface of the implant and abutment within an axial section of the distal region of the abutment and of the proximal region of the implant, in which section the accurately fittingly manufactured conical clamping surfaces of the at least one pair which effect the clamping connection between the implant and the abutment are arranged.

The accurately fitting conical clamping surface is defined as at least a part of a lateral surface of an inner cone in the clamping region of the distal region of the abutment, and the accurately fitting conical clamping surface of the implant is defined as at least a part of a lateral surface of an inner cone in the clamping region of the proximal region of the implant. In this text, the accurately fitting conical clamping surface is abbreviated as conical clamping surface or simply as clamping surface.

The at least one conical clamping surface of the proximal region of the implant is arranged in a cavity. The distal end of this cavity defines the distal end of the proximal region of the implant.

The distal region of the abutment comprising the at least one conical clamping surface, in the connected condition of the implant system is inserted into the cavity of the proximal region of the implant. The proximal end of the distal region of the abutment, in the connected condition of the implant system is arranged essentially at the same axial height (level) as the proximal end of the implant.

The outer cone and the corresponding inner cone in the clamping region are manufactured in pairs in an accurately fitting manner as a steep truncated cone with an identical or almost identical cone angle. An identical or almost identical cone angle permits the clamping effect that acts in the connected condition of the ceramic implant system when the outer cone is pressed into the inner cone. An almost identical cone angle in the region of the manufacturing possibilities has a difference between the cone angle of the inner cone and of the outer cone in the region of for example up to 0.5°, up to 1° or up to 1.5°, depending on the embodiment.

Such friction-fit connections or clamping connections between an outer cone and an inner cone are known in the state of the art from the principle of the Morse taper from the machine industry in the context of fastening and force transmission between a tool and a machine tool. Thereby, an outer cone of a tool for example is pressed into an inner cone of a machine tool and is firmly clamped. The cone angles of such known Morse cones from the tool industry lie in a region of 2° to 3°. Surprisingly, according to the present invention, this principle of the Morse cone can be applied to an implant system that is manufactured of ceramic.

Since ceramic is a brittle material, hoop stresses and tensile stresses must be avoided whenever possible with ceramic products, in order to prevent a material breakage as much as possible. For this reason, the technical design of the ceramic implant system according to the invention is optimised such that hoop and tensile stresses that could lead to implant breakages are minimal.

The clamping connection in the connected ceramic implant system arises as soon as the abutment is pressed into the implant. The adhesive friction between the overlapping regions of the lateral surfaces of the inner and outer cone must be overcome for removing an outer cone that is seated firmly in an inner cone. The accurately fittingly manufactured conical clamping surfaces overlap essentially at the same axial level in the connected implant system. The overlapping clamping surfaces of the implant and the abutment effect the clamping connection. Accordingly, large overlapping conical clamping surfaces favour a strong clamping connection. Moreover, the smaller the cone angle of the inner and outer cone, whose lateral surfaces or parts of whose lateral surfaces form the clamping surfaces, the stronger is the clamping connection.

A great advantage of the ceramic implant system according to the present invention is the fact that the clamping connection between the abutment and the implant acts over a large contact surface or friction surface. This leads to a strong connection and in particular also to a very large force transmission surface between the abutment and implant. The force transmission surface is significantly larger in comparison to ceramic implant systems known from the state of the art. Forces acting on the abutment in the connected implant system are transmitted onto the implant in a manner distributed over the force transmission surface, so that comparatively few high local stress peaks and fewer breakages occur with a large force transmission surface. The ceramic implant system is therefore comparatively more resistant to breakage that known two-part ceramic implant systems, with which a force acting on the abutment is only effected in a pointwise manner or over a smaller surface.

The magnitude of the cone angle of the outer and inner cone is selected small enough, in order to ensure an adequately strong clamping connection between the implant and the abutment in the connected implant system, and large enough to minimise the axial height of the inner cavity. The magnitude of the cone angle of the outer and inner cone lies in a region of 2° to 15°, in particular in a region with a lower limit of 2° to 3° or up to 4° and with an upper limit of 7° to 10° or up to 12° or in a region of 5° to 9°, 6° to 8°, or 6.5° to 7.5°.

With a very small cone angle of the outer cone and inner cone, for example below 3°, below 4° or below 5°, some embodiments are created with a manufacturing accuracy that is increased in comparison to embodiments with a greater cone angle. Some embodiments, whose conical clamping surfaces are the lateral surfaces or parts of lateral surfaces of an inner cone and outer cone with a very small cone angle, are manufactured with a maximal deviation between the cone angles of the inner cone and outer cone, which is not greater than 0.5° or 0.4° or 0.3°

In some embodiments, the clamping region comprises a single pair of accurately fitting conical clamping surfaces, specifically a conical clamping surface of the abutment and a conical clamping surface of the implant, said clamping surfaces in some of these embodiments both comprising a continuous lateral surface of the outer or inner cone. In other embodiments, the clamping region comprises several pairs of accurately fitting, conical clamping surfaces, for example lateral surfaces of the outer or the inner cone, which are interrupted, for example by way of neckings, grooves, indentations or cylindrical surfaces. In some exemplary embodiments with neckings or grooves, these run perpendicularly to the longitudinal axis of the abutment and of the implant or parallel to the longitudinal axis.

In some embodiments, the clamping region comprises several pairs of accurately fitting, conical clamping surfaces, specifically at least two conical clamping surfaces of the abutment and at least two conical clamping surfaces of the implant, which are the lateral surfaces of at least two outer cones of the abutment and inner cones of the implant, said surfaces being in each case adapted to one another in an accurately fitting manner. The at least two outer cones and inner cones that are in each case adapted to one another in an accurately fitting manner can have differently large cone angles. Accordingly, some of these embodiments with several pairs of accurately fitting conical clamping surfaces comprise differently steep clamping surfaces corresponding to the cone angle.

A middle axial level of the clamping region of the connected ceramic implant system with a pair of accurately fitting, conical clamping surfaces, abutments and implants is located in the middle between the proximal end of the one pair of accurately fitting, conical clamping surfaces and the distal end of these conical clamping surfaces. In embodiments with more than one pair of accurately fitting conical clamping surfaces, the middle axial level of the clamping region is located in the middle between the proximal end of the accurately fitting conical clamping surface which arranged furthest proximally and the distal end of the accurately fitting conical clamping surface which is arranged furthest distally.

A bone level of the implant or the implant system is defined as the proximal end of the enossal region of the implant. The enossal region of the implant extends from the distal end of the implant up to the bone level, thus up to that axial level of the implant or implant system, up to which the implant is envisaged for the anchoring and the ingrowth of the implant in the bone tissue.

In some embodiments, the bone level essentially corresponds to the proximal end of the thread run-out. In some embodiments, the enossal region is roughened, for example sand-blasted, and the bone level corresponds essentially to the proximal end of the sand-blasted region.

An embedding level is that axial level of an implant system, up to which this is embedded, for carrying out breakage tests according to the Isonorm 14801 (Status: 2013). The Isonorm 14801 specifies that the embedding level is arranged 3 mm distally to the bone level. From this, it results that in embodiments of the ceramic implant system with a middle axial level of the clamping region in a region between the bone level and embedding level, the middle axial level does not deviate by more than 1.5 mm from the middle between the bone level and the embedding level.

In some embodiments, the middle axial level of the clamping region differs by no more than 3 mm, and in particular, by no more than 2.5 mm or 2 mm, 1.5 mm, 1 mm or 0.5 mm from the middle between the bone level and the embedding level.

The middle axial level of the clamping region is a pivot point between the levers, which result with the transmission of forces from the abutment onto the implant. The material stresses are greatest at this pivot point and for this reason implant breakages are to be expected in particular at the middle axial level of the clamping region. The proneness to breakage is comparatively smaller with some embodiments of the implant system with a pivot point that lies distally of the bone level, or even further distally, for example essentially at the embedding level. Moreover, a greater wall thickness around the inner cavity in the proximal region of the implant decreases the proneness to breakage.

In some embodiments, the middle axial level of the clamping region is arranged at or directly distally of the embedding level, or for example in a region of up to 0.5 mm or 1 mm distally of the embedding level. In these embodiments, the lever effect of forces which are transmitted from the abutment onto the implant are minimised.

In some embodiments, the middle axial level of the clamping region or of the pivot point, for example is arranged at the middle between the bone level and the embedding level, or at an axial level in a region between the proximal end of the thread and the bone level, in particular in the region of the thread run-out. In these embodiments, the lever effect of forces which are transmitted from the abutment onto the implant is increased in comparison to the previously described embodiments, in which the pivot point is arranged at the embedding level. On the other hand, advantageously the wall thickness around the inner cavity in the proximal region of the implant is comparatively greater in exemplary embodiments, in which the pivot point is arranged at the middle between the bone level and the embedding level or at an axial level in a region between the proximal end of the thread and the bone level, in particular in the region of the thread run-out or directly proximally of the thread run-out, for example up to 0.5 mm proximally of the thread run-out. This is because the pivot point in these embodiments lies in a region proximal of the thread or proximal of the thread run-out.

Compared to this, the wall thickness around the inner cavity is smaller if the distal end of the inner cavity projects into the thread zone. In the thread zone, the root diameter of the thread is the important implant diameter for the breakage resistance. The root diameter, which is smaller than the implant diameter important for the breakage resistance, affects a smaller wall thickness of the inner cavity in the thread zone, where the inner cavity overlaps with the thread zone of the implant.

In some embodiments, the middle axial level of the clamping region is arranged up to 1 mm, up to 1.5 mm, up to 2 mm or up to 3 mm proximally of the middle between the bone level and the embedding level. In some embodiments, the middle axial level of the clamping region is up to 1 mm, up to 1.5 mm, up to 2 mm or up to 3 mm distally of the embedding level.

In some embodiments of the ceramic implant system, the clamping connection in the distal region of the abutment and the proximal region of the implant is supplemented by an additional bonding connection by way of at least one bonding zone in each case, which are assigned in pairs to one another in the distal region of the abutment and in the proximal region of the implant. An adhesive or bonding agent is deposited onto the abutment and/or onto the implant before the abutment is inserted into the implant, as is known from the state of the art for bonded, two-part ceramic implants. Such an additional bonding connection effects an additional securement of the connection of the abutment to the implant over a longer period of time, during which the implanted implant system is subjected to micro-movements.

In some embodiments of the ceramic implant system with at least one bonding zone, this or these are arranged distally or proximally of the clamping region. This means that in these embodiments, the implant and the abutment are provided with the at least one bonding zone in a manner such that the clamping region is free of the deposited adhesive. The at least one bonding zone is located for example at the distal end-surface of the abutment and accordingly at the distal end of the cavity in the proximal region of the implant and/or in at least one adhesive gap which for example is arranged in a cylindrical region of the abutment or of the implant proximally of the clamping region, and/or in a region close to the opening of the cavity in the proximal region of the implant in an inner structure which also serves as an insertion geometry, and/or in other zones of the proximal implant region which are arranged proximally of the clamping region.

In some embodiments of the ceramic implant system with an additional bonding connection, at least one bonding zone is arranged in the clamping region. In some of these embodiments, the conical clamping surfaces are interrupted by bonding zones. The bonding zone can at least partly overlap with one or more conical clamping zones, in these or other embodiments, in which at least one bonding zone is arranged in the clamping region. Bonding zones which overlap conical clamping surfaces are designed as an adhesive gap. Such an adhesive gap has a width which is equally as large as or almost as large as a grain size of the grains in the applied adhesive. This matching between the width of the adhesive gap and the grain size of the grains of the used adhesive, apart from the bonding connection, continues to ensure the clamping connection in the region of the conical clamping surfaces.

### BRIEF DESCRIPTION OF THE DRAWINGS

FIG. 1a is a perspective view of the exemplary abutment;

FIG. 1b is an elevation view of the exemplary abutment;

FIG. 1c is an elevation view of the exemplary abutment;

FIG. 2a is an elevation view of the exemplary implant;

FIG. 2b is a sectional elevation view of the exemplary implant comprising a proximal region of the implant;

FIG. 3a is an elevation view of the exemplary ceramic implant system; and

FIG. 3b is a sectional elevation view of the exemplary implant system.

### DETAILED DESCRIPTION OF THE INVENTION

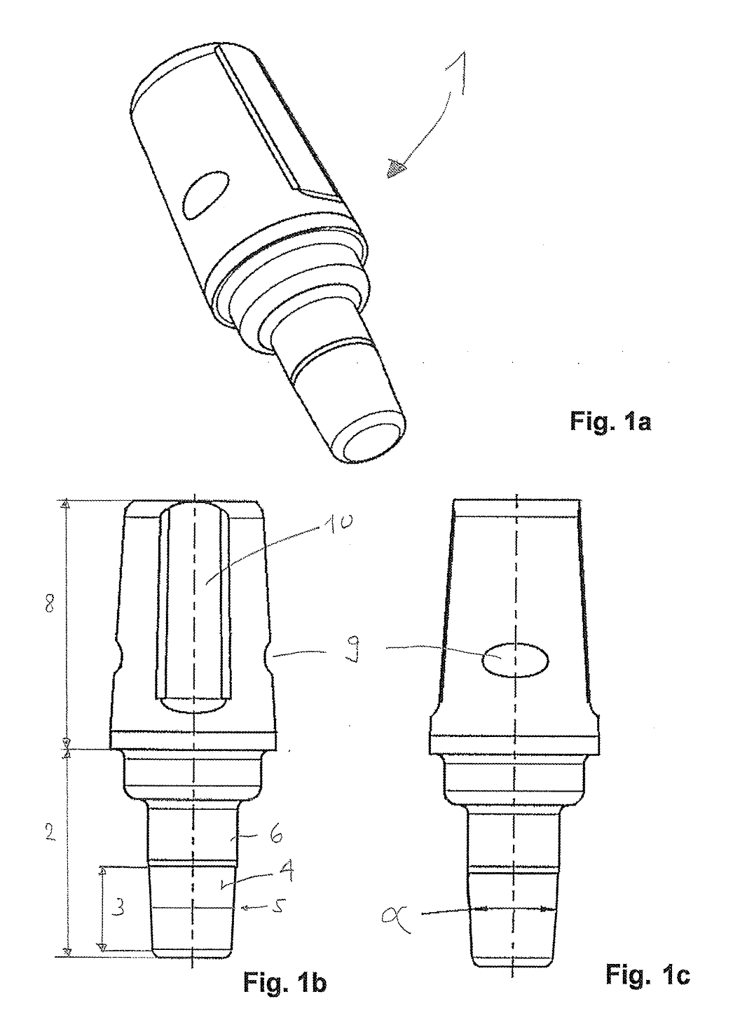

FIG. 1 shows an embodiment example of an abutment 1 of a ceramic implant system 40, wherein a perspective view onto the exemplary abutment is represented in FIG. 1a, a first lateral view in FIG. 1b and a second lateral view onto the exemplary abutment 1 in FIG. 1c.

The exemplary abutment 1 comprises a distal region 2 with a clamping region 3, in which a conical clamping surface 4 is arranged and said clamping region 3 having a middle axial level 5. The conical clamping surface 4 is a lateral surface of an outer cone in the clamping region 3. In this exemplary embodiment, the clamping region 3 only has one conical clamping surface 4 which extends over the complete clamping region 3. The middle axial level 5 of the clamping region 3 thus corresponds to the middle axial level of the outer cone. The outer cone is a steep cone and it has a cone angle α which for example is 2° to 15°.

In other exemplary embodiments of the abutment 1 which are not represented, several conical clamping surfaces 4 which in a paired manner with corresponding conical clamping surfaces 34 of the implant 20 are adapted to one another in an accurately fitting manner, are arranged in the clamping region 3. In embodiments of the abutment 1 with several conical sections 4 in the clamping region 3, the conical clamping surfaces 4 can be different parts of the lateral surface of an outer cone, for example because the lateral surface of this outer cone is interrupted by one or more neckings in the horizontal direction, grooves in the vertical direction or cylindrical sections or other surfaces. Moreover, in exemplary embodiments of abutments 1 with several clamping surfaces 4, these can be lateral surfaces or parts of lateral surfaces of different outer cones, wherein these embodiments are not shown.

The embodiment of the abutment 1 by way of example in FIG. 1 also has a cylindrical section 6 in the distal region 2. Moreover, the abutment 1 has a proximal region 8 which is arranged proximally of the distal region 2. The proximal region 8 of the abutment 1 is not inserted into the implant 11 of a ceramic implant system 30 and here serves for the connection of the abutment to superstructures such as crowns, bridges and likewise, wherein this connection is not shown. In some embodiments, the proximal region comprises a male for a commercially available female system for a denture, such as for example the Novaloc™ or Pro-Snap female systems known from the state of the art. In further embodiments which are not shown, the proximal region 8 of the abutment 1 has an angled stub or post.

The proximal region 8 of the exemplary abutment 1 represented in FIG. 1 has the same outer contours as an exemplary, non-shown single-part system with a holding structure 9 for a tool and with a ground side 10 for the transmission of a torque, so that the same tool as for the exemplary one-part system can be used.

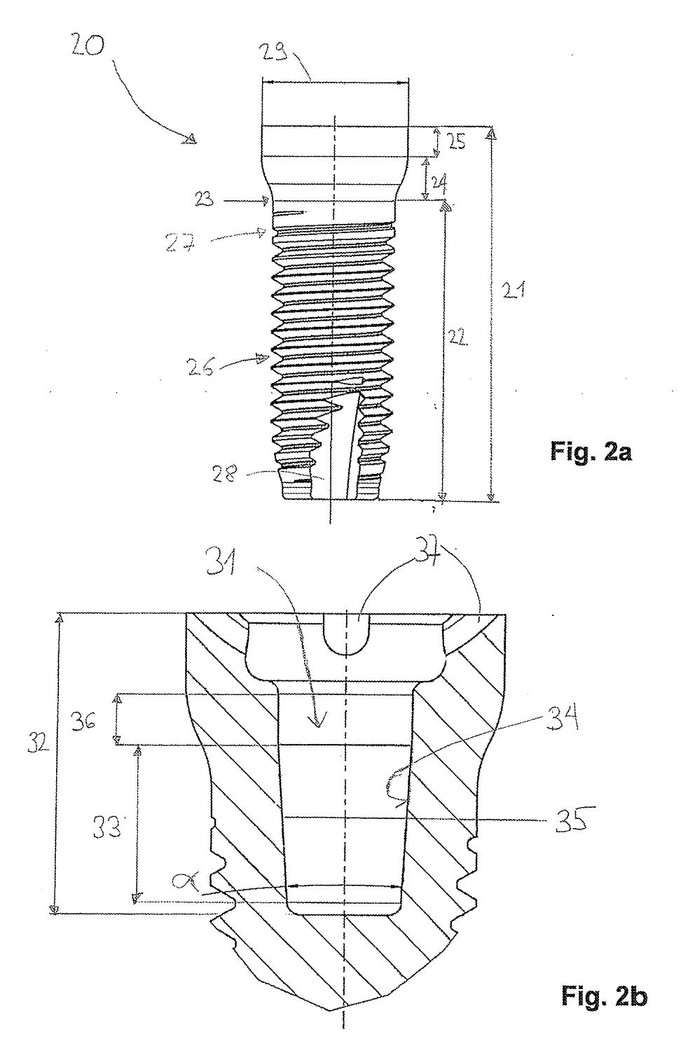

FIG. 2 shows an embodiment example of an implant 20 of a ceramic implant system 40, wherein a view onto the exemplary implant 20 is represented in FIG. 2a and a part section through the exemplary implant 20 having a proximal region 32 is shown in FIG. 2b.

The view onto the exemplary implant 20 which is represented in FIG. 2a has an implant length 21 which extends from the proximal to the distal end of the implant, and a thread zone 22 which extends from the distal end of the implant up to the proximal end of the thread 26 or the of thread run-out 27. The implant length 21 for example measures 6 mm to 16 mm, in particular 6 mm to 15 mm and the thread zone 22 for example measures 5 mm to 14 mm, in particular 8 mm to 13 mm. The represented exemplary embodiment of the implant 20, in a region towards a distal end of the thread zone 22 comprises at least one groove 28 with cutting edges.

An envisaged bone level 23 in some embodiments is envisaged for an axial level essentially at the proximal end of the thread or thread run-out. This means that in some embodiments, the envisaged bone level 23 is arranged directly at the end of the thread or thread run-out, or for example in some embodiments it is arranged up to 0.5 mm or up to 1 mm proximally of the end of the thread run-out.

In some embodiments of the implant, the bone level 23 is 7 mm to 14 mm, for example 8 mm, 9 mm, 10 mm, 11.5 mm or 13 mm. The bone level 23 of the implant 20 or of the implants system 40 shown by way of example is arranged at an axial level in a region between the proximal end of the thread run-out and the distal end of an exemplary tulip 24.

In the embodiment shown by way of example, the distal end of the exemplary tulip 24 is arranged directly proximally of the bone level 23. In the region of the tulip, the implant diameter widens from an outer diameter of the thread to the implant diameter 29 at the proximal end of the implant 20, which increases the breakage-resistance of the implant in the known manner. The outer diameter of the thread for example measures 3 mm to 6 mm, in particular 3.6 mm, 4 mm, 4.5 mm, 5 mm or 5.5 mm. The implant diameter 29 at the proximal end of the implant in such embodiments with a tulip 24 is greater than the outer diameter of the thread and it measures for example 0.5 mm to 1.5 mm more than the outer diameter of the thread. In the embodiment shown by way of example, a cylindrical zone 25 lies proximally of the tulip 24. In some embodiments of the implant 20 which are not shown here, an outer structure which serves as insertion geometry for an insertion tool, in order to rotate the implant 20 into a bone tissue is arranged in the cylindrical zone for example.

The part section which is shown in FIG. 2b and which includes a proximal region 32 of the exemplary implant 20, shows an inner cavity 31 which opens at a proximal face side of the implant 20 and into which the abutment 1 can be inserted. The distal end of the inner cavity 21 defines the distal end of the proximal region 32. This comprises a clamping region 33, in which a conical clamping surface 34 is arranged, with middle axial level 35. The conical clamping surface 34 is a lateral surface of an inner cone in the clamping region 33. In the shown exemplary embodiment, the clamping region comprises only one conical clamping surface 34 which extends over the whole clamping region 33. The middle axial level 35 of the clamping region 33 therefore corresponds to the middle axial level of the inner c one. The outer cone is a steep cone and it comprises a cone angle α, which for example is 2° to 15°.

In the embodiment example shown by way of example, the middle axial level 35 of the clamping region 33 is essentially arranged at the proximal end of the thread run-out. This arrangement of the middle axial level 35 or of a pivot point, corresponds to a compromise between an a distal as possible lowering or recessing of the middle axial level of the clamping region or of the pivot point in the enossal region of the implant one the one hand, and an arrangement in a region with an as large as possible wall thickness of the implant on the other hand.

In other exemplary embodiments of the implant which are not shown, several conical clamping surfaces 34 are arranged in the clamping region 33 and in a paired manner with corresponding conical clamping surfaces 4 of the abutment 1 are adapted to one another in an accurately fitting manner. In embodiments of the implant 20 with several conical clamping surfaces 34 in the clamping region 33, the conical clamping surfaces 34 can be different parts of the lateral surface of an inner cone, for example due to the fact that the lateral surface of an inner cone is interrupted by one or more neckings in the horizontal direction, grooves in the vertical direction or cylindrical sections or other surfaces. In further non-shown exemplary embodiments of implants 20 with several conical clamping surfaces, these can be lateral surfaces or parts of lateral surfaces, of different inner cones.

The embodiment of the implant 20 which is represented by way of example in FIG. 2b also comprises a cylindrical section 36 in the proximal region 32. Moreover, the implant 20 in the region of the proximal opening of the inner cavity 31 comprises inner structures 37 as an insertion geometry, into which one can engage with an insertion tool, in order to rotate the implant 20 into a bone tissue.

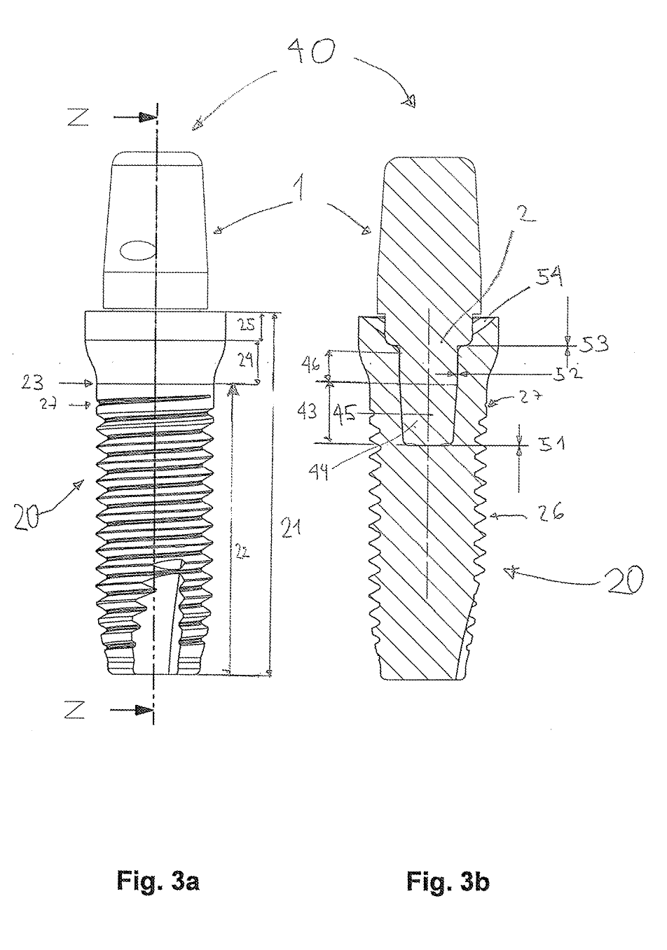

FIG. 3 shows an embodiment example of a ceramic implant system 40 in the connected condition, in an exemplary embodiment, with a clamping region and additionally with at least one bonding zone. FIG. 3a shows a view onto the exemplary ceramic implant system and FIG. 3b shows a section along a connection line between points N and N through the exemplary ceramic implant system.

In the ceramic implant system 40 represented by way of example, the distal region 2 of the exemplary abutment 1 is inserted into the cavity 37 of the exemplary implant 20, in the connected condition. The implant system 40, the abutment 1 and the implant 20 in the clamping region 3, 33, 43 comprise conical clamping surfaces 4, 34, 44 with an exemplary arrangement of the middle axial level 5, 35, 45 of the clamping region 3, 33, 43 in the region of the thread run-out 27.

The envisaged bone level 23 for the exemplary ceramic implant system 40 lies proximally of the thread run-out 27 in a region of least than 3 mm, in particular less than 2 mm, 1 mm or 0.5 mm above the middle axial level 5, 35, 45 of the clamping region 3, 33, 43.

The ceramic implant system shown by way of example comprises several optional bonding zones: a bonding zone 51 at the distal end of the abutment 1 or at the distal end of the proximal region 32 and of the cavity 37 of the implant 20; a bonding zone 52 in an adhesive gap along the cylindrical region 6, 36, 46: a bonding zone 53 in an adhesive gap arranged at a seat where the abutment 1 is seated in the cavity 31 of the implant 20; and a bonding zone 54 in the inner structure of the insert geometry. Further embodiments of ceramic implants systems which are not shown and which have an additional bonding connection comprise other, additional and/or not all of these bonding zones 51 to 54. In some embodiments with at least one bonding zone, this can also be arranged at a different location of the implant system, 40.

In some ceramic implant systems with one or more optional bonding zones, these are arranged in an adhesive gap of the connected implant system, or in the distal region of the abutment and/or in the proximal region of the implant. Such an adhesive gap can for example be arranged outside or outside as well as also at least partly within the clamping region and force transmission region. In some embodiments with adhesive gap, which in particular at least partly is arranged within the clamping region and force transmission region, this has a width which is matched to the grain size of a cement or adhesive, in particular a width in the region of up to 100 μm, or of 10 to 80 μm, of 20 to 70 μm or of 30 to 50 μm.

In some embodiments, the adhesive gap in the clamping region is formed by example by way of interruption of the lateral surface of the inner cone of the implant and/or of the outer cone of the abutment. Some of these embodiments comprise neckings or grooves in the conical clamping surfaces of the abutment and/or of the implant.

A further aspect of the invention relates to a set which contains the ceramic implant system and adhesive for at least one bonding zone.

1. A ceramic implant system comprising an implant with a proximal region having an inner cone and comprising an abutment with a distal region having an outer cone, wherein the distal region of the abutment and the proximal region of the implant in a clamping region in each case comprise at least one conical clamping surface which, in pairs, are adapted to one another in an accurately fitting manner such that the abutment and the implant of the ceramic implant system are connectable by way of a clamping connection.

2. The ceramic implant system according to claim 1, wherein the outer cone in the distal region of the abutment and the inner cone in the proximal region of the implant comprise a cone angle of the outer cone and the inner cone in a region of 1.5° to 15°.

3. The ceramic implant system according to claim 1, wherein a middle axial level of the clamping region does not deviate from the middle between a bone level and an embedding level by more than 3 mm.

4. The ceramic implant system according to claim 1, wherein the distal region of the abutment and the proximal region of the implant comprise at least one bonding zone.

5. The ceramic implant system according to claim 4, wherein the at least one bonding zone is arranged distally or proximally of the clamping region.

6. The ceramic implant system according to claim 5, wherein additionally at least one further bonding zone is arranged in the clamping region.

7. The ceramic implant system according to claim 4, wherein at least one bonding zone is arranged outside the conical clamping surfaces for the clamping connection.

8. The ceramic implant system according to claim 4, which in the connected condition comprises at least one adhesive gap in the distal region of the abutment or in the proximal region of the implant.

9. The ceramic implant system according to claim 8, wherein the adhesive gap is arranged outside or outside as well as at least partly within the clamping region.

10. The ceramic implant system according to claim 8, wherein a width of the adhesive gap within the clamping region is matched to a grain size of an adhesive or cement.

11. A set comprising a ceramic implant system according to claim 4 and adhesive for at least one bonding zone.

12. The ceramic implant system according to claim 2, wherein the cone angle of the outer cone and the inner cone have lower limit of 2° to 4°, and an upper limit of 7° to 12°.

13. The ceramic implant system according to claim 2, wherein the distal region of the abutment and the proximal region of the implant comprise at least one bonding zone.

14. The ceramic implant system according to claim 13, wherein the at least one bonding zone is arranged distally or proximally of the clamping region.

15. The ceramic implant system according to claim 14, wherein additionally at least one further bonding zone is arranged in the clamping region.

16. The ceramic implant system according to claim 3, wherein the distal region of the abutment and the proximal region of the implant comprise at least one bonding zone.

17. The ceramic implant system according to claim 16, wherein the at least one bonding zone is arranged distally or proximally of the clamping region.

18. The ceramic implant system according to claim 17, wherein additionally at least one further bonding zone is arranged in the clamping region.

19. The ceramic implant system according to claim 5, wherein at least one bonding zone is arranged outside the conical clamping surfaces for the clamping connection.

20. The ceramic implant system according to claim 6, wherein at least one bonding zone is arranged outside the conical clamping surfaces for the clamping connection.
